(19) United States
(12) Patent Application Publication
(10) Pub. No.: US 2014/0089066 A1
(43) Pub. Date: Mar. 27, 2014

(54) METHODS FOR MANAGING REFERRALS AND DEVICES THEREOF

(71) Applicant: PMB MARKETING LLC, Neptune, NJ (US)

(72) Inventor: Paul Sansone, JR., Neptune, NJ (US)

(73) Assignee: PMB Marketing LLC, Neptune, NJ (US)

(21) Appl. No.: 13/627,771

(22) Filed: Sep. 26, 2012

(51) Int. Cl. G06Q 30/02

(52) U.S. Cl. 705/14.16

(57) ABSTRACT

A method, non-transitory computer readable medium, and a referral management server that identifies a user type stored in a referral network database as associated with login credentials submitted by a user of a computing device. At least summary information and pending transaction information is determined based on the identified user type and the login credentials wherein, when the identified user type is a referral agent, the pending transaction information comprises at least a status of one or more sales leads previously submitted by the user and the summary information comprises an indication of a consummated sale associated with one or more of the previously submitted sales leads. A dashboard web page including at least the summary information and the pending transaction information is generated. The generated dashboard web page is sent to the computing device.

### FIELD

This technology generally relates to methods and devices for managing referral sources and sales leads and, more particularly, to methods and devices for managing a referral network to incentivize and accelerate marketing and sales lead generation by referral agents.

### BACKGROUND

Product and service sales in many industries are facilitated by customer relationships and referrals by those within a professional, personal, or other network. Such word-of-mouth, relationship-based referrals are often the most effective source of advertising leading to a higher conversion rate of prospective customers to sales.

However, there is currently no effective way to manage and grow a referral network that efficiently incentivizes referral sources and facilitates increased sales. Even when an incentive is offered for a successful referral, a referral source may not have the ability to determine whether a sale was ultimately consummated and, therefore, may not be able to take advantage of an offered incentive. Additionally, successful referrals can result from a chain of referral sources, some or all of which may be unable to track a referral and/or collect the offered incentive. Such ineffective referral processes and incentive systems can negatively affect sales, which is undesirable.

### SUMMARY

A method for managing referrals includes identifying, with a referral management server, a user type stored in a referral network database as associated with login credentials submitted by a user of a computing device. At least summary information and pending transaction information is determined, with the referral management server, based on the identified user type and the login credentials wherein, when the identified user type is a referral agent, the pending transaction information comprises at least a status of one or more sales leads previously submitted by the user and the summary information comprises an indication of a consummated sale associated with one or more of the previously submitted sales leads. A dashboard web page including at least the summary information and the pending transaction information is generated, with the referral management server. The generated dashboard web page is sent, with the referral management server, to the computing device.

A non-transitory computer readable medium having stored thereon instructions for managing referrals includes machine executable code which when executed by a processor, causes the processor to perform steps including identifying a user type stored in a referral network database as associated with login credentials submitted by a user of a computing device. At least summary information and pending transaction information is determined based on the identified user type and the login credentials wherein, when the identified user type is a referral agent, the pending transaction information comprises at least a status of one or more sales leads previously submitted by the user and the summary information comprises an indication of a consummated sale associated with one or more of the previously submitted sales leads. A dashboard web page including at least the summary information and the pending transaction information is generated. The generated dashboard web page is sent to the computing device.

A referral management sever apparatus includes a processor coupled to a memory and configured to execute programmed instructions stored in the memory including identifying a user type stored in a referral network database as associated with login credentials submitted by a user of a computing device. At least summary information and pending transaction information is determined based on the identified user type and the login credentials wherein, when the identified user type is a referral agent, the pending transaction information comprises at least a status of one or more sales leads previously submitted by the user and the summary information comprises an indication of a consummated sale associated with one or more of the previously submitted sales leads. A dashboard web page including at least the summary information and the pending transaction information is generated. The generated dashboard web page is sent to the computing device.

This technology provides a number of advantages including providing methods, non-transitory computer readable medium, and devices that effectively facilitate management of a referral network for an entity and sales agents associated with the entity. With this technology, referral agents are effectively incentivized to refer prospective customers to the entity and/or sales agents.

### BRIEF DESCRIPTION OF THE DRAWINGS

FIG. 1 is a block diagram of an exemplary network environment which incorporates computing devices coupled to an exemplary referral management server;

FIG. 2 is a flowchart of an exemplary method for managing referrals;

FIG. 3 is an exemplary system agent dashboard web page for facilitating registration of entities and/or entity representatives;

FIG. 4 is an exemplary entity representative dashboard web page for facilitating management of information for sales agents and sales leads associated with an entity;

FIG. 5 is a an exemplary sales lead listing web page for displaying information regarding sales leads associated with an entity;

FIG. 6 is an exemplary sales agent dashboard web page for facilitating management of information for referral agents and sales leads associated with a sales agent; and

FIG. 7 is an exemplary referral agent dashboard web page for facilitating management of information for referral agents and sales leads associated with a referral agent.

### DETAILED DESCRIPTION

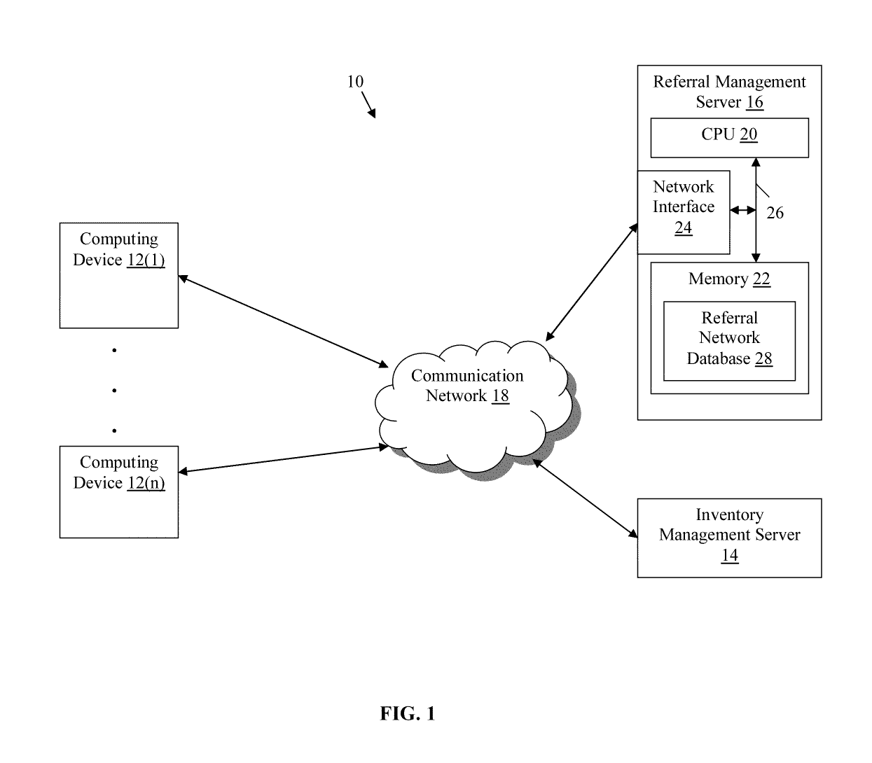

An exemplary environment 10 with computing devices 12(1)-12(n), an inventory management server 14, and a referral management server 16 coupled by a communication network 18 is illustrated in FIG. 1, although this environment 10 can include other numbers and types of systems, devices, components, and elements in other configurations, such as multiple referral management servers 16 and communication networks 18. While not shown, the environment 10 also may include additional network components, such as routers, switches and other devices, which are well known to those of ordinary skill in the art and thus will not be described here. This technology provides a number of advantages including providing methods, non-transitory computer readable medium, and devices that effectively manage referral network information and facilitate and incentivize referral agents.

The computing devices 12(1)-12(n) each include a central processing unit (CPU) including one or more processors, a memory, a network interface, and an input and display device interface, which are coupled together by a bus or other link, although other numbers and types of systems, devices, components, and elements in other configurations and locations can be used. The CPU in each of the computing devices 12(1)-12(n) executes a program of stored instructions for one or more aspects of the present technology as described and illustrated by way of the examples herein.

The memory in each of the computing devices 12(1)-12(n) stores these programmed instructions for one or more aspects of the present technology, as described and illustrated herein, although some or all of the programmed instructions could be stored and/or executed elsewhere. The memory in the client computing devices 12(1)-12(n) optionally stores programmed instructions for a web browser for using the network interface to operatively exchange content with the referral management server 16. One or more of the computing devices 12(1)-12(n) may be a personal desktop or laptop computer, a cellular telephone, a tablet computer, or any other type of computationally-enabled, user-carried device.

The referral management server 16 includes a CPU 20 including one or more processors, a memory 22, and a network interface 24, which are coupled together by a bus 26 or other link, although other numbers and types of systems, devices, components, and elements in other configurations and locations can be used. The referral management server 16 can include a database server and/or a web server and a plurality of these and/or other servers can also be provided. The CPU 20 in the referral management server 16 executes a program of stored instructions for one or more aspects of the present technology as described and illustrated by way of the examples herein, although other types and numbers of processing devices and configurable hardware logic could be used and the CPU 20 could execute other numbers and types of programmed instructions.

The memory 22 in the referral management server 16 stores these programmed instructions for one or more aspects of the present technology as described and illustrated herein, although some or all of the programmed instructions could be stored and executed elsewhere. In some examples, the memory 22 includes a referral network database 28 for storing referral information, as described and illustrated in more detail below. A variety of different types of memory storage devices, such as a random access memory (RAM) or a read only memory (ROM) in the system or a floppy disk, hard disk, CD ROM, DVD ROM, or other non-transitory computer readable medium which is read from and written to by a magnetic, optical, or other reading and writing system that is coupled to the CPU 20, can be used for the memory 22.

The network interface 24 in the referral management server 16 is used to operatively couple and communicate between the referral management server 16 and the computing devices 12(1)-12(n) and inventory management server 14 via the communications network 18, although other types and numbers of communication networks or systems with other types and numbers of connections and configurations can be used. By way of example only, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The inventory management server 14 includes a CPU including one or more processors, a memory, a network interface, which are coupled together by a bus or other link, although other numbers and types of systems, devices, components, and elements in other configurations and locations can be used. The CPU in the inventory management server 14 executes a program of stored instructions for one or more aspects of the present technology as described and illustrated by way of the examples herein. The memory in of the inventory management server 14 stores these programmed instructions for one or more aspects of the present technology, as described and illustrated herein, although some or all of the programmed instructions could be stored and/or executed elsewhere.

Although examples of the referral management server 16, computing devices 12(1)-12(n), and inventory management server 14, which are coupled together via the communication network 18 are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s). Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer device(s) that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

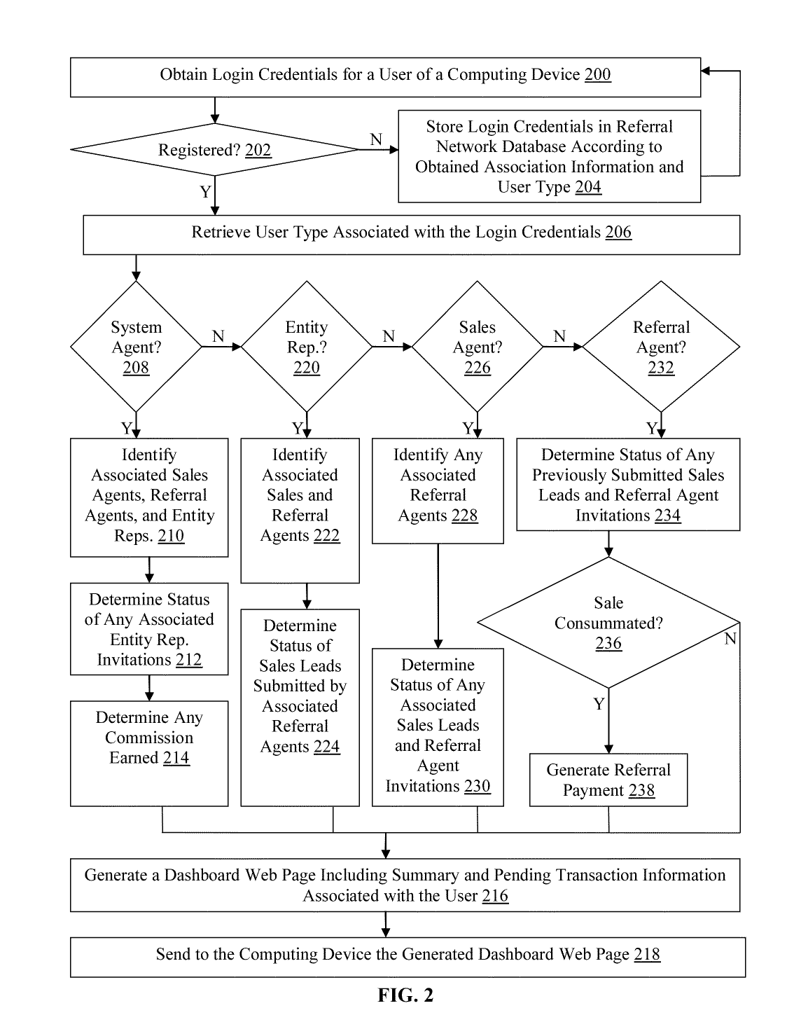

Exemplary methods and devices for managing referrals will now be described with reference to FIGS. 1-7. Referring specifically to FIG. 2, in step 200, the referral management server 16 obtains login credentials from a user of one of the computing devices 12(1)-12(n). In step 202, the referral management server 16 determines whether the user has previously registered by attempting to authenticate the login credentials, such as by comparing the credentials to a plurality of previously registered credentials stored in the referral network database 28. If the referral management server 16 determines the user has not previously registered, then the No branch is taken to step 204.

In step 204, the referral management server 16 provides a registration web page to the user of the computing deice 12(1)-12(n). Optionally, for unregistered users, the registration web page can be accessed directly and without initially submitting login credentials in step 200. For example, the registration web page can be accessed based on a link communicated to a user of one of the computing device 12(1)-12(n) by the referral management server 16 in response to an invitation from a previously registered user, as described and illustrated in more detail later. The registration web page is configured to receive from the user, and communicate to the referral management server 16, the login credentials, association information, and an indication of the user's type.

The association information can indicate that the user is associated with one or more entity representatives, sales agents, or referral agents previously registered with the referral management server 16. The user type can be at least one of a system agent, entity representative, a sales agent, or a referral agent, although other user types can also be indicated. The user type indication is used by the referral management server 16 to classify a user and to generate and provide dashboard and other web pages to the user according to the classification, as described and illustrated in more detail below.

In this example, the referral management server 16 stores the login credentials in the memory 22, such as in the referral network database 28, along with the association information and user type. In some examples, a user can have more than one user type. For example, a user can be a representative of a first entity and also a referral agent associated with a sales agent of a second entity, for example, although other combinations of user types can also be used.

If the referral management server 16 determines, in step 202, that the login credentials are authenticated, and the user has previously registered, then the Yes branch is taken to step 206. In step 206, the referral management server 16 retrieves a user type associated with the login credentials, such as the user type stored in the referral network database 28 as associated with the user's login credentials in step 204. In examples in which the user is associated with multiple user types, the referral management server 16 can send the user of the one computing device 12(1)-12(n) a selection web page allowing the user to identify one of the user types to be associated with the login session, although other methods of identifying a user type to be associated with the login session can also be used.

Based on the retrieved user type and login credentials, the referral management server 16 communicates with the referral network database 28 to determine summary information and pending transaction information. The summary and pending transaction information is used to generate a dashboard web page sent to the user's computing device 12(1)-12(n), as described and illustrated in detail below.

In step 208, the referral management server 16 determines whether the user type associated with the obtained login credentials indicate that the user is of a system agent user type. System agent users can facilitate registration of entity representatives with the referral management server 16. If the referral management server 16 determines the user type associated with the login credentials is a system agent, then the Yes branch is taken to step 210.

In step 210, the referral management server 16 identifies one or more sales agent, referral agent, and/or entity representative users associated with the system agent user. In this example, the referral management server 16 can communicate with the referral network database 28 to retrieve an indication of the associated users based on the association information stored in step 204. The associated users can be identified based on a direct link to the user or based on one or more indirect links. For example, the system agent user can be directly linked to an entity representative user, which can be an owner of an automobile dealership for which the system agent user facilitated registration with the referral management server 16. Associated with the entity representative in the referral network database 28 can be a plurality of automobile salespeople or sales agent users. These sales agents are indirectly linked to the system agent user but can also be identified in step 210. Other associations and direct and indirect links can also be identified in step 210. Additionally, the automotive industry is used herein for exemplary purposes only and the referral management server 16 can be used with any other industry as well as across industries or with respect to multiple industries.

In step 212, the referral management server 16 determines a status of one or more entity representative invitations associated with the system agent user. Entity representative invitations can be facilitated by the referral management server 16 as described and illustrated below. Information regarding the entity representative invitations sent by the system agent user using the referral management server 16 can be stored in the referral network database 28 and associated with the system agent user, such as through the system agent user's login credentials.

In step 214, the referral management server 16 optionally determines a commission earned by the user based on the identified one or more sales agents, referral agents, or entity representatives. Accordingly, the system agent user can be compensated by the administrator or operator of the referral management server 16 based on the number of entity representatives, for example, directly associated with the system agent user and for which the system agent user has facilitated registration with the referral management server 16. Other methods of determining a commission or otherwise compensating system agent users can also be used.

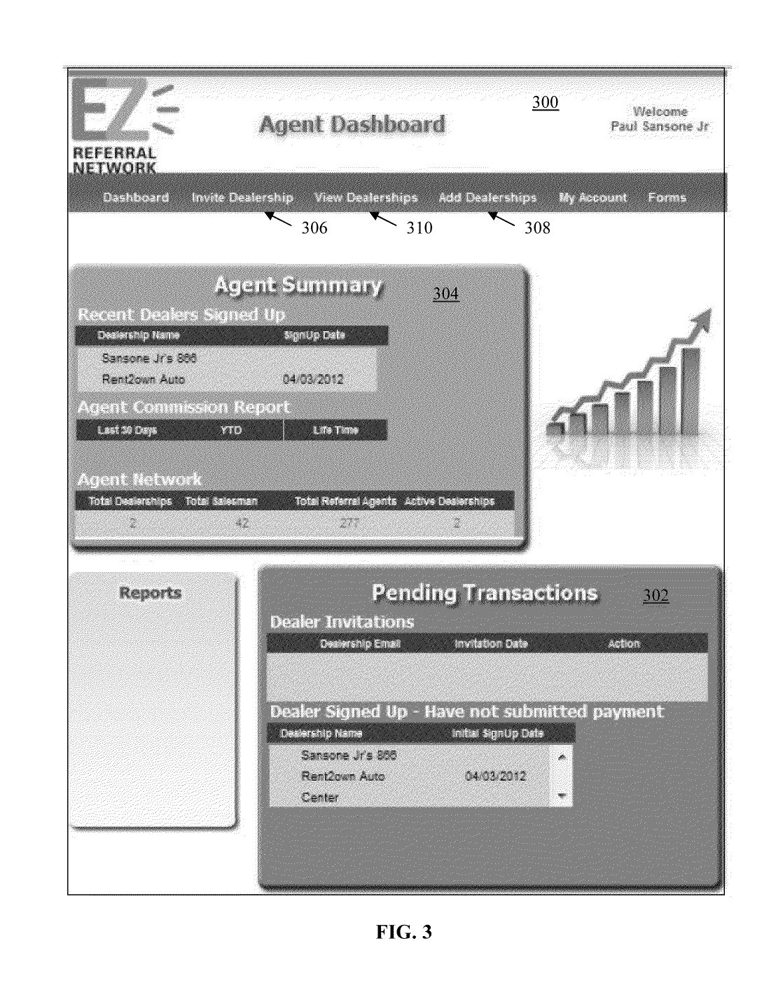

In step 216, the referral management server 16 generates a dashboard web page configured to be rendered in a web browser of the system agent user's computing device 12(1)-12(n). An exemplary system agent dashboard web page 300 is shown in FIG. 3. In this example, the entities are automobile dealerships, although any entity type can be used, including for profit business and charitable organizations, and dashboard web pages, or templates thereof, for multiple entity types can be stored in the memory 22. The generated dashboard web page 300 includes pending transaction information 302 and summary information 304. The pending transaction information 302 can include the status of the entity representative invitations determined in step 212. The summary information 304 can include the commission determined in step 214. The summary information 304 can further include an indication of the identified sales agents, referral agents, or entity representatives identified in step 210, such as in a list form and/or accessible by one or more hyperlinks.

In step 218, the referral management server 16 sends the generated system agent dashboard web page 300 to the user's computing device 12(1)-12(n). In this example, the system agent user can interact with the system agent dashboard web page 300 by selecting the invite dealership button 306 which is linked to form submission web page(s) stored and/or generated by the referral management server 16. The form submission web pages(s) are configured to receive entity representative information from the system agent user and send the information to the referral management server 16. In this example, the system agent user can also select the add dealership button 308 which is linked to one or more web page(s) configured to display previously authenticated entity representatives stored in the referral network database 28 that the sales agent can identify as associated entity representatives.

Upon submission of the entity representative information, the referral management server 16 can send an invitation, such as a link to the registration web page discussed earlier with respect to step 204, to the invited entity representative user. Traversing the link can cause the association information field to be automatically populated with an indication of the system agent user that is the source of the invitation. Accordingly, when the invited entity representative user registers in step 204, the associated login credentials, or other unique identifier, can be associated with the system agent user in the referral network database 28.

The system agent dashboard web page 300 can also include a view dealerships button 310 including a link to web page(s) stored and/or generated by the referral management server 16 and configured to display all of the dealerships associated with entity representative users associated with the system agent user, for example. The displayed dealerships associated with the system agent user can be those dealerships for which the system agent user has facilitated registration of an associated entity representative with the referral management server 16. Other reports and statistics can be also generated and/or displayed and other functionality can also be provided by the system agent dashboard web page 300.

Referring back to step 208, if the referral management server 16 determines that the user type retrieved in step 206 is not a system agent, then the No branch is taken to step 220. In step 220, the referral management server determines whether the user type retrieved in step 206 is an entity representative. The entity representative users can be employees, managers, or other personnel of or associated with an entity, such as an automobile dealership in this example. If the referral management server 16 determines in step 220 that the user type retrieved in step 206 is an entity representative, then the Yes branch is taken to step 222.

In step 222, the referral management server 16 identifies one or more sales agent users and/or referral agent users associated with the entity representative user. In this example, the referral management server 16 can communicate with the referral network database 28 to retrieve an indication of the associated users based on the association information stored in step 204. The associated users can be identified based on a direct link to the user or based on one or more indirect links, as described earlier with respect to step 210.

In step 224, the referral management server 16 determines the status of any sales leads previously submitted by any of the referral agent users identified as associated with the entity representative user in step 222. Sales leads can be submitted by referral agent users and stored in the referral network database 28, as described and illustrated below. Additionally, sales leads and associated statuses can be updated as described and illustrated below and retrieved from the referral network database 28 in step 224.

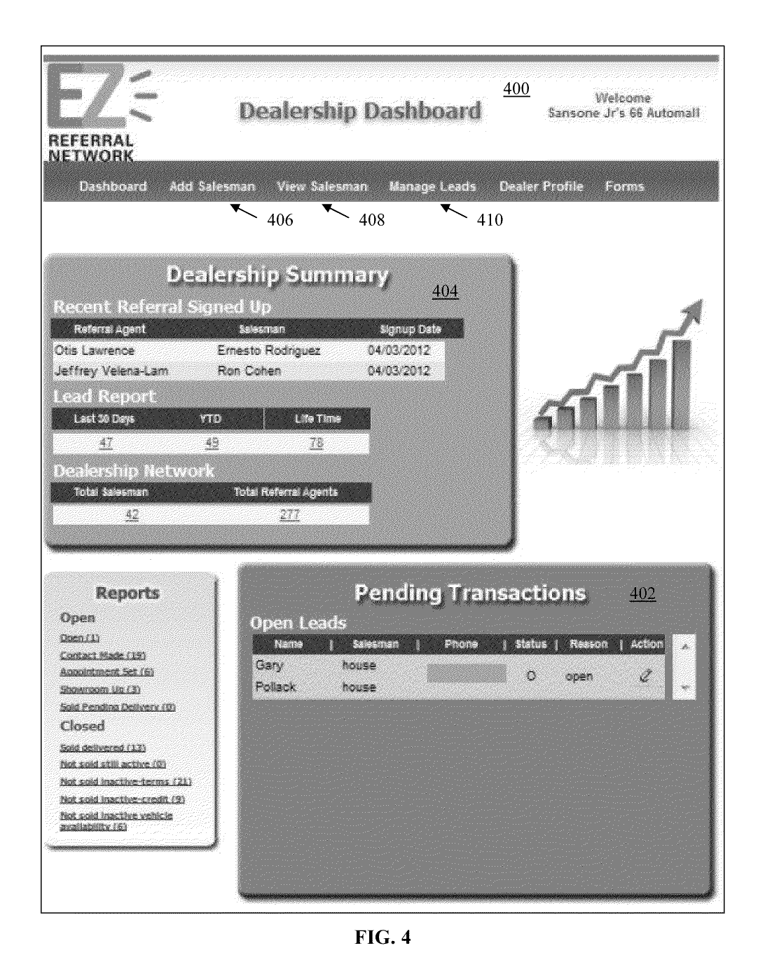

In step 216, the referral management server 16 generates a dashboard web page configured to be rendered in a web browser of the user's computing device 12(1)-12(n). An exemplary entity representative dashboard web page 400 is shown in FIG. 4. The generated dashboard web page 400 includes pending transaction information 402 and summary information 404. The pending transaction information 402 can include the status of the sale leads determined in step 224. The summary information 404 can include an indication of the identified sales agent users and/or referral agent users identified in step 222, such as in a list form and/or accessible by one or more hyperlinks.

In step 218, the referral management server 16 sends the generated entity representative dashboard web page 400 to the user's computing device 12(1)-12(n). In this example, the entity representative user can interact with the entity representative dashboard web page 400 by selecting the add salesman button 406 to add information regarding one or more sales agent users associated with the entity representative user. The add salesman button 406 can be linked to form submission web page(s) stored and/or generated by the referral management server 16 and configured to facilitate the selection of previously registered sales agent users. Upon receipt of the selected sales agent user information, the referral management server 16 can associated the selected sales agent user(s) with the entity representative that added the sales agent user(s).

In order to retrieve information regarding the sales agent users associated with the entity representative user, the entity representative user can select the view salesman button 408, for example. The view salesman button 408 can be linked to reporting web page(s) stored and/or generated by the referral management server 16 and configured to display sales agent user information associated with the entity representative and stored in the referral network database 28.

Associated sales leads can be managed by the entity representative, including with respect to updating the status in the referral network database 28, using the manage leads button 410. Other attributes, such as the category of the sales lead and the sales agent to be provided the sales lead for follow-up, can also be managed by the entity representative user. The manage leads button 410 of the entity representative dashboard web page 400 can be linked to sales lead listing web page(s) stored and/or generated by the referral management server 16 and configured to display and facilitate the management of sales leads associated with sales and/or referral agent users associated with the entity representative user.

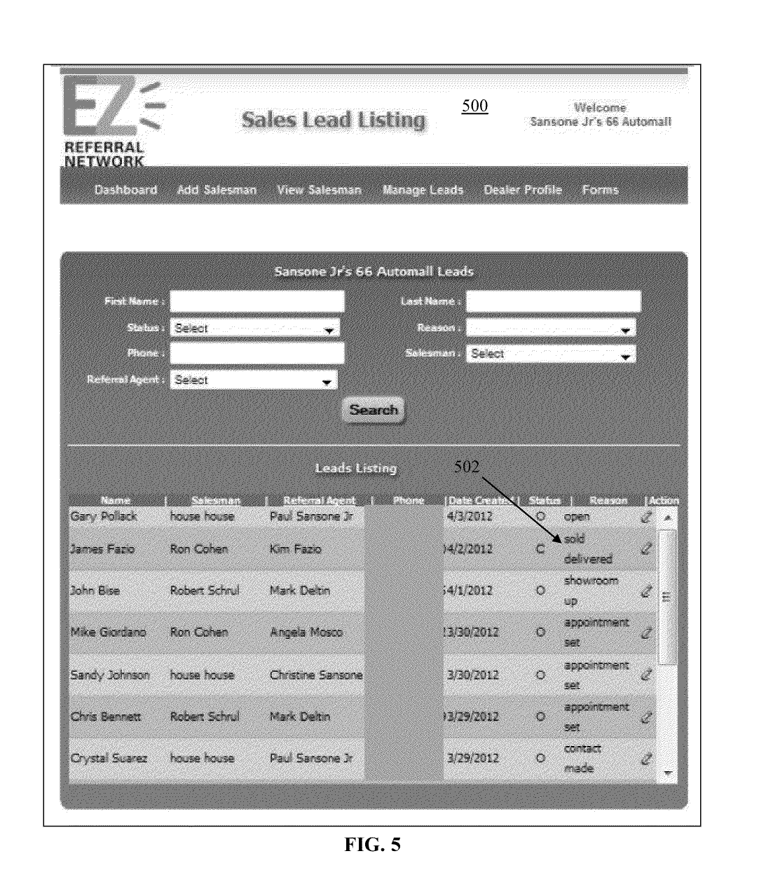

Referring to FIG. 5, an exemplary sales lead listing web page 500 is shown. The sales lead listing web page 500 is configured to display information regarding sales leads associated with the entity representative user including the status 502 of the associated sales leads. In this example, the status 502 of the sales leads can be modified by the entity representative user to indicate that the prospective customer associated with the sales lead has visited the show room or that a sale has been consummated with the prospective customer, for example.

Referring back to step 220, if the referral management server 16 determines that the user type retrieved in step 206 is not an entity representative, then the No branch is taken to step 226. In step 226, the referral management server 16 determines whether the user type retrieved in step 206 is a sales agent. The sales agent users can be those persons associated with an entity for purposes of selling products or services of the entity, such as automobile salespeople associated with an automobile dealership entity in this example. If the referral management server 16 determines in step 226 that the user type retrieved in step 206 is a sales agent, then the Yes branch is taken to step 228.

In step 228, the referral management server 16 identifies one or more referral agents associated with the sales agent user. In this example, the referral management server 16 can communicate with the referral network database 28 to retrieve an indication of the associated referral agent users based on the association information stored in step 204. The associated referral agent users can be identified based on a direct link to the user or based on one or more indirect links, as described earlier with respect to steps 210 and 222.

In step 230, the referral management server 16 determines the status of any sales leads previously submitted by any of the referral agent users identified as associated with the sales agent user in step 228. Sales leads can be submitted by referral agent users and stored in the referral network database 28, as described and illustrated below. Sales leads and associated statuses can be stored in the referral network database 28, updated as described and illustrated below, and retrieved from the referral network database 28 in step 230.

In this example, at step 230, the referral management server 16 also determines a status of one or more referral agent invitations associated with the sales agent user. Referral agent invitations can be facilitated by the referral management server 16 as described and illustrated below. Information regarding the referral agent invitations sent by the sales agent user using the referral management server 16 can be stored in the referral network database 28 and associated with the sales agent, such as through the sales agent user's login credentials or other unique identifier.

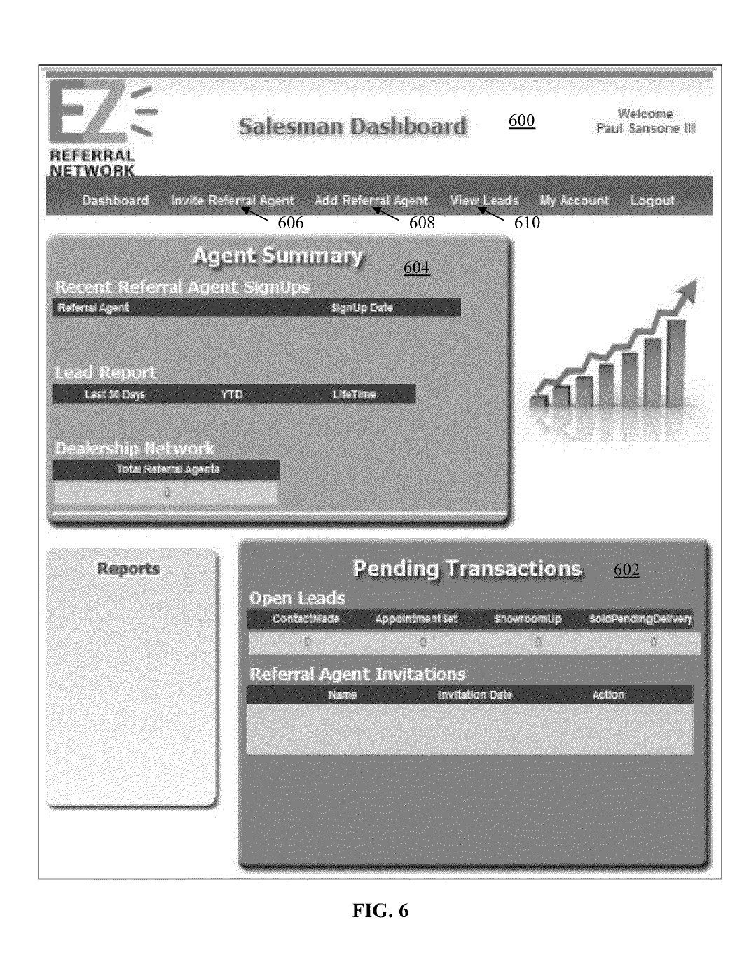

In step 216, the referral management server 16 generates a dashboard web page configured to be rendered in a web browser of the user's computing device 12(1)-12(n). An exemplary sales agent dashboard web page 600 is shown in FIG. 6. The generated dashboard web page 600 includes pending transaction information 602 and summary information 604. The pending transaction information 602 can include the status of the sale leads and/or the referral agent invitations determined in step 230. The summary information 604 can include an indication of the referral agents identified in step 228, such as in a list form and/or accessible by one or more hyperlinks.

In step 218, the referral management server 16 sends the generated sales agent dashboard web page 600 to the user's computing device 12(1)-12(n). In this example, the sales agent user can interact with the sales agent dashboard web page 600 by selecting the invite referral agent button 606 which is linked to form submission page(s) stored and/or generated by the referral management server 16. The form submission web pages(s) are configured to receive referral agent information from the sales agent user and send the information to the referral management server 16. The referral management server 16 can then send an invitation to the invited referral agent user, such as a link to the registration web page discussed earlier with respect to step 204. Traversing the link can cause the association information field to be automatically populated with an indication of the sales agent user that is the source of the invitation. Accordingly, when the invited referral agent registers in step 204, the associated login credentials, or other unique identifier, can be associated with the sales agent user in the referral network database 28.

In this example, the sales agent user can further select the add referral agent button 608 of the sales agent dashboard web page 600 which is linked to one or more web page(s) configured to display previously authenticated referral agent users that the sales agent user can identify as an associated referral agent user. Additionally, the sales agent user can interact with the view leads button 610 of the sales agent dashboard web page 600, which can be linked to web page(s) stored and/or generated by the referral management server 16 and configured to display sales leads associated with referral agents associated with the sales agent user, as described and illustrated earlier with respect to the sales lead listing web page 500 shown in FIG. 5. Other reports and statistics can be also generated and/or displayed and other functionality can also be provided by the sales agent dashboard web page 600.

Referring back to step 226, if the referral management server 16 determines that the user type retrieved in step 206 is not a sales agent, then the No branch is taken to step 232. In step 232, the referral management server 16 determines whether the user type retrieved in step 206 is a referral agent. The referral agent users can be those persons that are referral sources for other referral agents, sales agents, and/or entity representatives, for example. If the referral management server 16 determines in step 232 that the user type retrieved in step 206 is not a referral agent, then a No branch (not shown) is taken and an error web page or the registration web page discussed above with respect to step 204 can be sent to the user's computing device 12(1)-12(n) by the referral management server 16. If the referral management server 16 determines in step 232 that the user type retrieved in step 206 is a referral agent, then the Yes branch is taken to step 234.

In step 234, the referral management server 16 determines the status of any sales leads previously submitted by the referral agent user. Optionally, the referral management server 16 identifies any other referral agent users associated with the referral agent user and determines, in step 234, the status of any sales leads associated with any of the identified referral agent users. Sales leads can be submitted to the referral management server 16 by referral agents and stored in the referral network database 28 as described and illustrated below. Sales leads and associated statuses can be stored in the referral network database 28, updated as described and illustrated earlier with respect to the sales lead listing web page 500 of FIG. 5, and retrieved from the referral network database 28 in step 234.

In this example, at step 234, the referral management server 16 also determines a status of one or more referral agent invitations associated with the referral agent user. Information regarding the referral agent invitations sent by the referral agent user using the referral management server 16 can be stored in the referral network database 28 and associated with the referral agent, such as through the referral agent user's login credentials or other unique identifier.

In step 236, the referral management server 16 determines whether a sale has been consummated with a prospective customer identified in one of the sales leads as determined in step 234 and for which the referral agent has not previously been compensated. In one example, the referral management server 16 can determine whether a sale has been consummated based on an indication associated with the sales lead as stored in the referral network database 28, as described and illustrated earlier with respect to steps 224, 230, and 234.

In another example, the referral management server 16 can determine that a sale has been consummated from an external system, such as an inventory management system 14 used by an entity representative or a sales agent user to process sales and/or store inventory information. In this example, the inventory management system 14 can be a dealer management system 14 configured to obtain information regarding an automobile sale from an entity representative or sales agent user of a computing device 12(1)-12(n). The inventory management system 14 can automatically send an indication of the sale to the referral management server 16, or respond to a periodic query from the referral management server 16, using the communication network 18, for example. While steps 234-238 can occur upon an authenticated login of a user of a computing device 12(1)-12(n) having an associated referral agent user type, steps 234-238 can also be performed by the referral management server 16 at any time and while a referral agent user is not logged into the referral management server 16.

If the referral management server 16 determines in step 236 that at least one sale has been consummated with a prospective customer identified in at least one sales leads submitted by the referral agent user then the Yes branch is taken to step 238. In step 238, the referral management server 16 generates a referral fee payment to the referral agent user for each consummated sale determined in step 236. In one example, the referral fee payment is generated as a direct deposit to a personal account based on account information submitted during the registration process in step 204 and stored in the referral network database 28. In another example, the referral fee payment is generated and mailed as a prepaid credit card or check based on contact information submitted during the registration process in step 204 and stored in the referral network database 28. In yet another example, the referral fee payment is generated as a deposit to an account associated with the entity with which the customer consummated the sale as a credit to be used toward a future purchase by the referral agent user.

Additionally, a referral payment can be generated in step 238 to an entity representative user associated with the referral agent user in an arrangement in which referral agents in a referral agent group are employees of, or associated with an organization level including, an entity associated with the entity representative user, for example. In this exemplary arrangement, only the entity, as represented by the entity representative user, may be compensated and not the referral agent user employee. Other types of referral fee payments and methods of generating a referral fee payment to the referral agent user can also be used.

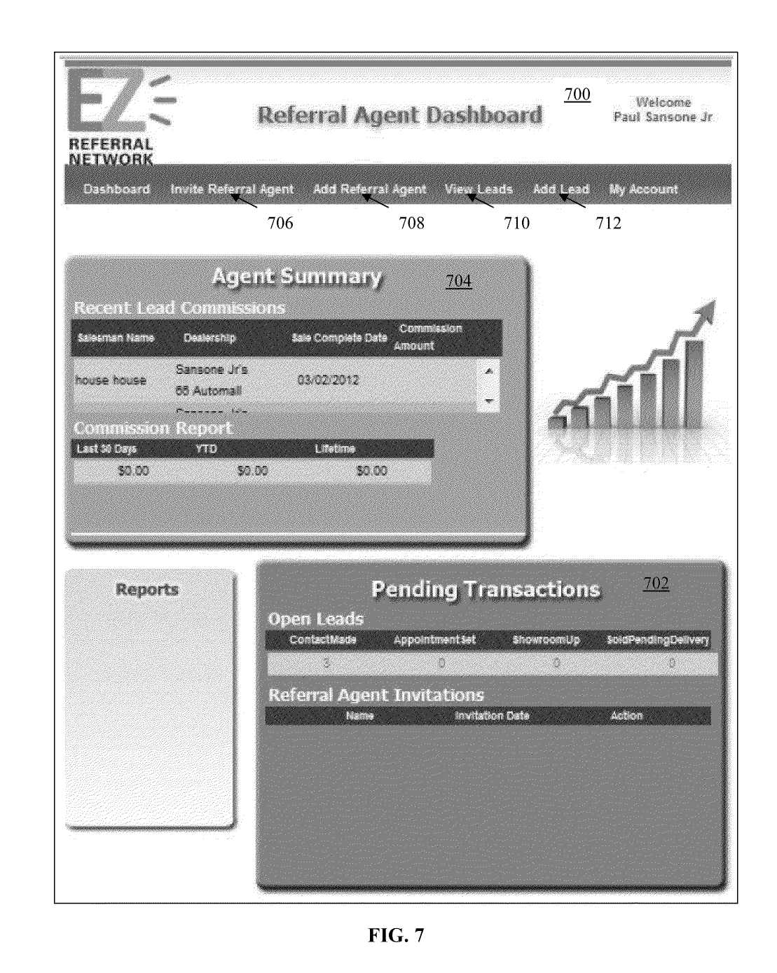

Once a payment has been generated in step 238, or if the referral management server 16 determines that no sales have been consummated and the No branch is taken from step 236, in step 216, the referral management server 16 generates a dashboard web page configured to be rendered in a web browser of the user's computing device 12(1)-12(n). An exemplary referral agent dashboard web page 700 is shown in FIG. 7. The generated dashboard web page 700 includes pending transaction information 702 and summary information 704. The pending transaction information 702 can include the status of the sale leads and/or the referral agent invitations determined in step 234. Optionally, the pending transaction information 702 can further include commission information associated with the referral fee payment generated in step 238, and/or any previously generated referral fee payments, as retrieved from the referral network database 28. The summary information 704 can include an indication of the consummated sales determined in step 236. Other reports and statistics can be also generated and/or displayed and other functionality can also be provided by the referral agent dashboard web page 700.

Accordingly, a referral agent can advantageously view the status of any sales lead, such as to determine whether a prospective customer has been contacted, has set up an appointment, has visited a showroom, and/or has consummated a sale with the dealership in this example. The ability to track the status of sales leads, and automatically receive a reward for successful sales leads, provides increased transparency, which can increase incentive for referral agents to expand referral networks and generate sales leads, thereby resulting in increased sales for an associated entity.

In step 218, the referral management server 16 sends the generated referral agent dashboard web page 700 to the user's computing device 12(1)-12(n). In this example, the referral agent user can interact with the referral agent dashboard web page 700 by selecting the invite referral agent button 706 which is linked to form submission page(s) stored and/or generated by the referral management server 16, as described and illustrated above with respect to the invite referral agent button 606. In this example, the referral agent user can further select the add referral agent button 708 of the referral agent dashboard web page 700 which is linked to one or more web page(s) configured to display previously authenticated referral agents that the referral agent user can identify as an associated entity representative user, as described and illustrated earlier with respect to the add referral agent button 608. Additionally, the referral agent user can interact with the view leads button 710 of the referral agent dashboard web page 700 which can be linked to web page(s) stored and/or generated by the referral management server 16 and configured to display sales leads associated with referral agents associated with the sales agent, as described and illustrated earlier with respect to the view leads button 610 and the sales lead listing web page 500 shown in FIG. 5.

The referral agent user can further interact with the referral agent dashboard web page 700 to submit a sales lead using the add lead button 712. The add lead button 712 can be linked to form submission web page(s) stored and/or generated by the referral management server 16 and configured to facilitate submission of a sales lead. The sales lead can include information regarding the prospective customer, such as contact information, products or services the prospective customer may be most interested in, such as a specific automobile in this example, the category of the sales lead, and/or the context leading to the submission of the sales lead. The submitted sales lead is optionally stored by the referral management server 16, such as in the referral network database 28. Optionally, an indication of an association of the sales lead to the submitting referral agent user is also stored by the referral management server 16 in the referral network database 28. Based on the stored indication, the appropriate referral agent(s) can be rewarded upon any consummation of a sale, as described and illustrated in detail earlier with respect to step 238.

Optionally, the referral management server 16 provides the submitted sales lead to one of the entity representative and/or one of the sales agent users. In order to appropriately provide the sales lead, the referral management server 16 can query the referral network database 28 to identify any sales agent or entity representative users associated with the referral agent source of the sales lead. Optionally, the referral agent user can include an indication of an entity representative or sales agent user to whom the submitted sales lead should be directed.

In some examples, an automatic notification is sent by the referral management server 16 to the entity representative and/or sales agent user that will process the sales lead and attempt to consummate a sale. In other examples, the referral management server 16 can make the sales lead available to the entity representative and/or sales agent user by displaying the sales lead in web page(s) provided in response to selection of the manage leads button 410 and/or view leads button 610. Other methods of providing submitted sales leads to one or more users of the referral management server 16 can also be used.

Optionally the referral management server 16 generates and sends a sales survey to the prospective customer. The survey can be in the form of a web page and the link to the web page can be sent by the referral management server 16 to the customer based on electronic mail contact information included by the referral agent in the sales lead submitted using the add lead button 712.

Optionally, a sales survey can be generated and sent by the referral management server 16 for any prospective customer at any time during the sale process. The survey can provide an additional basis for determining whether the status of a sales lead is appropriately stored by the referral management server 16, particularly with respect to whether a sale has been consummated.

Also optionally, the referral management server 16 can be configured to display the various web pages of the system, including the dashboard web pages 300, 400, 600, and 700, in multiple languages based on multiple versions stored by the referral management server 16. The displayed language can be selected by a user of one of the computing devices 12(1)-12(1n) or determined based on a geographic association of the user's internet protocol (IP) address, for example. Additionally, the graphical display of the various web pages of the system, including the dashboard web pages 300, 400, 600, and 700, can be based on a “skin” or graphical template, for example, such that the visual presentation is customized for one or more users and/or entities.

Additionally, in examples in which referral agents are organized in groups in the referral network database, such as based on a common association with an entity as established with the associated information submitted in step 204, the referral management server 16 can facilitate cross marketing by entities. Accordingly, an entity representative user associated with a first entity can submit, using one of the computing devices 12(1)-12(n), a request to the referral management server 16 to send a discount offer for its services to the referral agent users associated with a second entity. The referral management server 16 can then use obtained contact information, an internal message system, and/or the referral agent dashboard 700 to service the request for participating users. Other methods of facilitating cross-marketing can also be used.

By this technology, referral agents are incentivized to grow referral networks and submit sales leads for prospective customers to associated entity representative and/or sales agent users. Thereby, sales lead generation can be increased and the generated sales leads are more likely to be relatively effective, relationship-based leads. Additionally, with this technology, referral agent users can relatively easily obtain the status of any submitted sales lead to determine whether a sales has resulted, as well as whether any reward has been earned or generated, thereby advantageously providing efficiency and transparency to the referral process.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing referrals, comprising:
identifying, with a referral management server, a user type stored in a referral network database as associated with received login credentials of a user from a computing device;
determining, with a referral management server, at least summary information and pending transaction information based on the identified user type and the login credentials wherein, when the identified user type is a referral agent, the pending transaction information comprises at least a status of one or more sales leads previously submitted and the summary information comprises an indication of a consummated sale associated with one or more of the previously submitted sales leads;
generating, with the referral management server, a dashboard web page including at least the summary information and the pending transaction information; and
sending, with the referral management server, the generated dashboard web page to the computing device.

2. The method of claim 1, further comprising registering, with the referral management server, a plurality of users comprising:
obtaining login credentials, a user type, and association information for each of the plurality of users, wherein the association information includes an indication of a least one previously registered entity representative, sales agent, or referral agent; and
storing the login credentials in a referral network database as associated with the user type and association information.

3. The method of claim 1, wherein the determining further comprises:
obtaining the indication of a consummated sale associated with the one or more of the previously submitted sales leads from an inventory management server; and
generating a referral fee payment to based on the obtained indication.

4. The method of claim 1, wherein the determining further comprises, when the identified user type is a system agent:
identifying one or more sales agents, referral agents, or entity representatives associated with the user;
determining a status of one or more entity representative invitations associated with the user; and
determining a commission earned by the user based on the identified one or more sales agents, referral agents, or entity representatives;
wherein the pending transaction information further comprises the status of the entity representative invitations and the summary information further comprises the commission and an indication of the identified sales agents, referral agents, or entity representatives.

5. The method of claim 1, wherein the determining further comprises, when the identified user type is an entity representative:
identifying one or more sales agents or one or more referral agents associated with the user;
determining a status of one or more sales leads previously submitted by the one or more referral agents associated with the user; and
wherein the pending transaction information further comprises the status of the one or more sales leads and the summary information further comprises an indication of the identified sales and referral agents.

6. The method of claim 1, wherein the determining further comprises, when the identified user type is a sales agent:
identifying one or more referral agents associated with the user including one or more other referral agents associated with the one or more referral agents;
determining a status of one or more sales leads previously submitted by the one or more referral agents associated with the user and one or more referral agent invitations associated with the user; and
wherein the pending transaction information further comprises the status of the sales leads or the referral agent invitations and the summary information further comprises an indication of the identified referral agents.

7. A non-transitory computer readable medium having stored thereon instructions for managing referrals comprising machine executable code which when executed by a processor, causes the processor to perform steps comprising:
identifying a user type stored in a referral network database as associated with received login credentials of a user from a computing device;
determining at least summary information and pending transaction information based on the identified user type and the login credentials wherein, when the identified user type is a referral agent, the pending transaction information comprises at least a status of one or more sales leads previously submitted by the user and the summary information comprises an indication of a consummated sale associated with one or more of the previously submitted sales leads;
generating a dashboard web page including at least the summary information and the pending transaction information; and
sending the generated dashboard web page to the computing device.

8. The medium of claim 7, further having stored thereon instructions that when executed by the processor cause the processor to perform steps further comprising registering a plurality of users of computing device comprising:
obtaining login credentials, a user type, and association information for each of the plurality of users, wherein the association information includes an indication of a least one previously registered entity representative, sales agent, or referral agent; and
storing the login credentials in a referral network database as associated with the user type and association information.

9. The medium of claim 7, wherein the determining further comprises;
obtaining the indication of a consummated sale associated with the one or more of the previously submitted sales leads from an inventory management server; and
generating a referral fee payment based on the obtained indication.

10. The medium of claim 7, wherein the determining further comprises, when the identified user type is an system agent:
identifying one or more sales agents, referral agents, or entity representatives associated with the user;
determining a status of one or more entity representative invitations associated with the user;
determining a commission earned by the user based on the identified one or more sales agents, referral agents, or entity representatives; and
wherein the pending transaction information further comprises the status of the entity representative invitations and the summary information further comprises the commission and an indication of the identified sales agents, referral agents, or entity representatives.

11. The medium of claim 7, wherein the determining further comprises, when the identified user type is an entity representative:
identifying one or more sales agents associated with the user or an entity represented by the user;
identifying one or more referral agents associated with the user including one or more referral agents associated with at least one of one or more sales agents associated with the user or one or more other referral agents associated with the one or more referral agents;
determining a status of one or more sales leads previously submitted by the one or more referral agents associated with the user; and
wherein the pending transaction information further comprises the status of the one or more sales leads and the summary information further comprises an indication of the identified sales and referral agents.

12. The medium of claim 7, wherein the determining further comprises, when the identified user type is a sales agent:
identifying one or more referral agents associated with the user including one or more other referral agents associated with the one or more referral agents; and
determining a status of one or more sales leads previously submitted by the one or more referral agents associated with the user and one or more referral agent invitations associated with the user;
wherein the pending transaction information further comprises the status of the sales leads or the referral agent invitations and the summary information further comprises an indication of the identified referral agents.

13. A referral management server apparatus comprising a memory coupled to one or more processors which are configured to execute programmed instructions stored in the memory comprising
identifying a user type stored in a referral network database as associated with received login credentials of a user from a computing device;
determining at least summary information and pending transaction information based on the identified user type and the login credentials wherein, when the identified user type is a referral agent, the pending transaction information comprises at least a status of one or more sales leads previously submitted by the user and the summary information comprises an indication of a consummated sale associated with one or more of the previously submitted sales leads;
generating a dashboard web page including at least the summary information and the pending transaction information; and
sending the generated dashboard web page to the computing device.

14. The apparatus of claim 13, wherein the processor is further configured to execute programmed instructions stored in the memory further comprising registering a plurality of users of computing device comprising:
obtaining login credentials, a user type, and association information for each of the plurality of users, wherein the association information includes an indication of a least one previously registered entity representative, sales agent, or referral agent; and
storing the login credentials in a referral network database as associated with the user type and association information.

15. The apparatus of claim 13, wherein the determining further comprises;
obtaining the indication of a consummated sale associated with the one or more of the previously submitted sales leads from an inventory management server; and
generating a referral fee payment based on the obtained indication.

16. The apparatus of claim 13, wherein the determining further comprises, when the identified user type is a system agent:
identifying one or more sales agents, referral agents, or entity representatives associated with the user;
determining a status of one or more entity representative invitations associated with the user;
determining a commission earned by the user based on the identified one or more sales agents, referral agents, or entity representatives; and
wherein the pending transaction information further comprises the status of the entity representative invitations and the summary information further comprises the commission and an indication of the identified sales agents, referral agents, or entity representatives.

17. The apparatus of claim 13, wherein the determining further comprises, when the identified user type is an entity representative:
identifying one or more sales agents associated with the user or an entity represented by the user;
identifying one or more referral agents associated with the user including one or more referral agents associated with at least one of one or more sales agents associated with the user or one or more other referral agents associated with the one or more referral agents; and
determining a status of one or more sales leads previously submitted by the one or more referral agents associated with the user;
wherein the pending transaction information further comprises the status of the one or more sales leads and the summary information further comprises an indication of the identified sales and referral agents.

18. The apparatus of claim 13, wherein the determining further comprises, when the identified user type is a sales agent:
identifying one or more referral agents associated with the user including one or more other referral agents associated with the one or more referral agents;
determining a status of one or more sales leads previously submitted by the one or more referral agents associated with the user and one or more referral agent invitations associated with the user; and
wherein the pending transaction information further comprises the status of the sales leads or the referral agent invitations and the summary information further comprises an indication of the identified referral agents.
